(19) United States
(12) Patent Application Publication
(10) Pub. No.: US 2012/0155116 A1
(43) Pub. Date: Jun. 21, 2012

(54) HIGH EFFICIENCY EDGE-LIT LIGHT FIXTURE

(75) Inventor: Robert C. Gardner, Atherton, CA (US)

(73) Assignee: Lunera Lighting Inc., Redwood City, CA (US)

(21) Appl. No.: 12/973,678

(22) Filed: Dec. 20, 2010

(51) Int. Cl. F21V 7/22; G02B 6/00

(52) U.S. Cl. 362/609; 362/612; 264/1.24

(57) ABSTRACT

This is directed to a LED light fixture having a light guide array with a retroreflective element used to redirect light into the light guide array, and methods for constructing the same. A LED light fixture includes a LED module providing light and an elongated light guide array placed adjacent to the LED module. Light emitted by the LED module propagates through the light guide array and is redirected by the light guide array into the environment of the fixture. To prevent light from propagating through the end of the light guide array opposite the LED module, the light guide array can include angled facets forming a retroreflective element at an end of the light guide array for redirecting light back into the LGA.

### BACKGROUND

Light fixtures provide a source of light to illuminate dark environments. A light fixture can be constructed from a light source placed in contact with a light guide for directing light from the light source into an environment. To improve the efficiency of the light fixture, and to reduce costs associated with illumination, a light emitting diode (LED) module can be used as a light source. A LED-based light fixture, however, may be subject to several mechanisms that reduce the efficiency of the fixture. In some cases, light provided by a LED module may propagate through a light guide and out of a far end (e.g., a trailing edge) of the light guide. This lost light may substantially decrease the efficiency of the light fixture.

### SUMMARY

LED-based light fixtures having a light guide with a retroreflective element and methods for creating the same are provided. In particular, light fixtures having a LED light source connected to one end of a rectangular prism-shaped light guide array. The end of the light guide array that is opposite the LED light source can be cut or shaped to create a retroreflective element such that light reaching the end of the light guide array may be reflected back into the light guide array.

A LED light fixture can include a LED module serving as a light source. The LED module may provide a light output that is substantially in a Lambertian distribution. To guide the light towards an environment, a light guide array (LGA) can be coupled to the light source such that light from the light source can be redirected towards the environment. In some cases, the LGA can be constructed such that substantially all of the light emitted by the light source may be frustrated by the LGA as it propagates through the LGA. In this manner, light emitted by the LED module can be redirected by the LGA to the environment of the light fixture.

Some of the light emitted by the LED module, however, may propagate through the entire LGA without being frustrated, and may pass through a trailing edge of the LGA. To improve the efficiency of the LGA, the LGA can include a retroreflective element at the trailing edge to redirect light back from the trailing edge towards the LGA. In some cases, the trailing edge can be shaped to include two angled facets forming a point at the trailing edge. The angles of the facets can be selected based on the index of refraction between the material of the LGA and air such that light reaching the facets is reflected internally within the LGA. In particular, if the index of refraction between the LGA and the environment is 1.5, the facets can be angled at more than a critical angle of 42 degrees. To ensure that light reflected by the facets is turned around, the facets can be angled at substantially 90 degrees relative to each other.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a side view of an illustrative light fixture in accordance with some embodiments of the invention;

FIG. 2A is a side view of a light fixture having a modified light guide array for improving efficiency in accordance with some embodiments of the invention;

FIG. 2B are side, end and top views of a light guide array in accordance with some embodiments of the invention;

FIG. 3 is a detailed view of a second end of a modified light guide array in accordance with some embodiments of the invention; and

FIG. 4 is a flow chart of an illustrative process for constructing a light guide array having a retroreflective element in accordance with some embodiments of the invention.

### DETAILED DESCRIPTION

This is directed to an edge-lit LED light fixture having an elongated light guide array (LGA) to which a LED light source is coupled at a first end. A second end of the LGA, opposite the first end, can include at least two angled facets forming a retroreflective element for reflecting light emitted by the LED that reaches the second end back into the LGA.

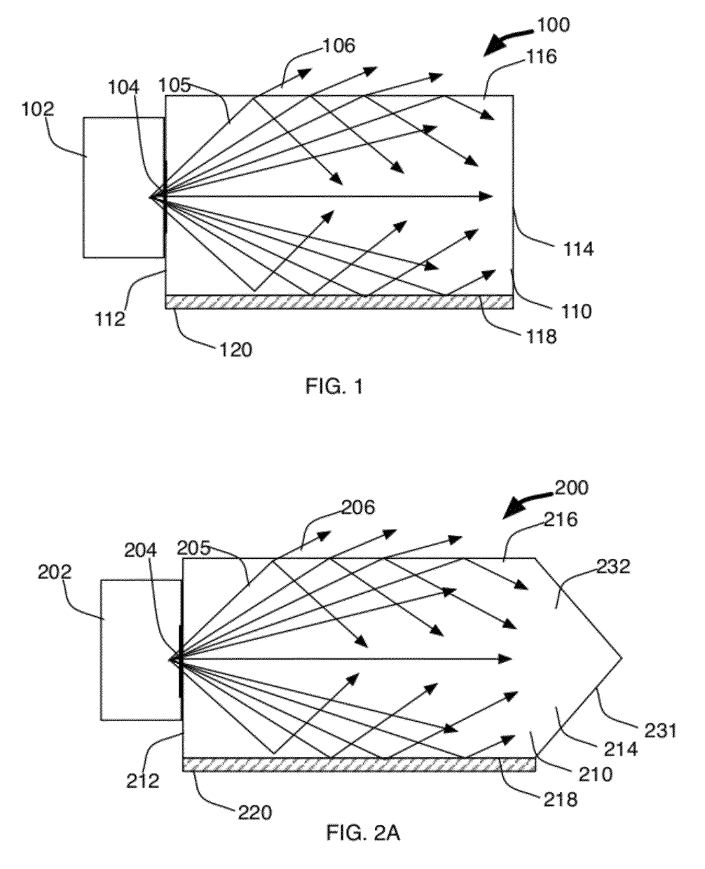

A light fixture that uses a LED module as a light source can be mounted in several different manners. In some cases, a light fixture can be mounted to a ceiling, mounted under a counter, as part of a desk light, as a wall sconce, as a wall wash, as a surface mounted light fixture, or combinations of these. Light emitted by the LED module can be directed into the environment from the fixture by a light guide array (LGA). FIG. 1 is a side view of an illustrative light fixture in accordance with some embodiments of the invention. Fixture 100 can include LED module 102 providing light from light emitting surface 104. Emitted light 105 propagates through light guide array 110 (LGA 110) positioned adjacent to LED module 102. LGA 110 can include an extended structure defined such that light provided into the LGA is directed into the environment through one surface of the LGA. For example, LGA 110 can include an elongated body such that light is directed out of top boundary 116 of LGA 110, but not out of bottom boundary 118 of LGA 110.

LED module 102 can provide light to LGA 110 using different approaches. In particular, LED module 102 may be placed in contact with or adjacent to first end 112 of LGA 110 such that light enters LGA 110 from first end 112 and is propagated towards second end 114. Light 105 entering LGA 110 can be reflected in part by upper boundary 116 and lower boundary 118. In some cases, reflective component 120 (e.g., a separate reflective element offset from lower boundary 118) can be applied to or near lower boundary 118 to improve the reflectivity of lower boundary 118 and reduce losses of light leaving LGA 110 through lower boundary 118. Some portions 106 of light 105, however, may be frustrated by ribs or other features incorporated in LGA 110, such that portions 106 of light 105 leave LGA 110 through upper boundary 116. These portions 106 may serve to illuminate the environment in which fixture 100 is placed.

LGA 110 can include any suitable waveguide for guiding light waves from a source into an environment. In some cases, LGA 110 can include a slab or planar waveguide, a rib waveguide, or any other type of waveguide. In some cases, LGA 110 can include several guides combining to redirect light from a LED module. Although, in the following discussion, LGA 110 is described as a rectangular prism light guide array, it will be understood that any waveguide can be used with a LED module as part of a light fixture.

LGA 110 can have any suitable size or shape. In some cases, the size and shape used for a particular LGA can vary based on the desired use of a light fixture. For example, LGA 110 can substantially define a rectangular prism having sides that are constrained within planes. Adjacent sides of the LGA can be provided at substantially right angles. The rectangular prism can have any suitable dimensions including, for example, a height of 150 mm (e.g., 6″), a width of 5 mm (e.g., 0.2″) and a length in the range of 300 mm to 2500 mm (e.g., 1′ to 8′).

In some cases, LGA 110 can include a non-rectangular three-dimensional shape. For example, LGA 110 can include a triangular prism, or any other non-rectangular polygonal prism. As another example, LGA 110 can include one or more sides that are not planar (e.g., curved surfaces). LGA 110, however, may include at least one elongated side such that a LED module is only provided on one end of the elongated LGA.

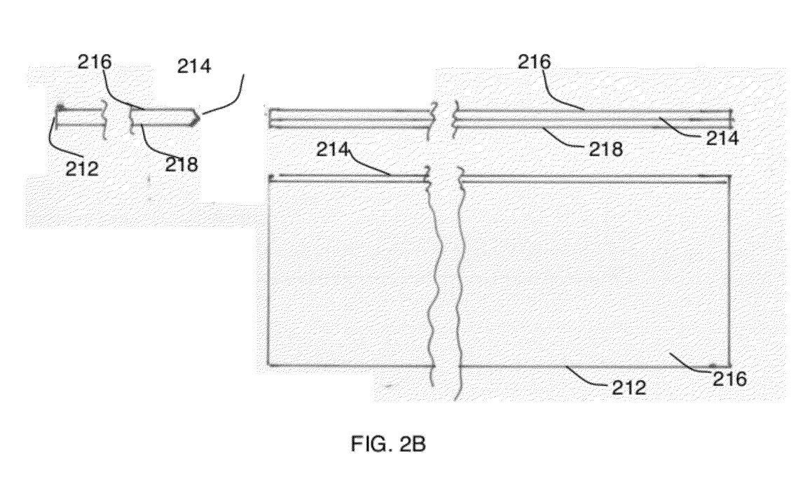

Some of light 106, however, may propagate through the entirety of LGA 110 and may leave LGA 110 through second end 114. This can substantially reduce the efficiency of fixture 100, and limit its desirability. Accordingly, LGA 110 can be modified such that light reaching second end 114 can be turned around and re-directed towards LGA 110. FIG. 2A is a side view of a light fixture having a modified light guide array for improving efficiency in accordance with some embodiments of the invention. Light fixture 200 can include LED module 202 and LGA 210 having some or all of the features of light fixture 100 (FIG. 1). LGA 210 can include first end 212 adjacent to source 204 of LED module 202, upper boundary 216 through which light may escape LGA 210, and lower boundary 218 adjacent to which reflecting component 220 is placed. LGA 210 can include second end 214 opposite first end 212 and shaped to reflect light reaching second end 214 back towards first end 212. In particular, second end 214 can include angled facets 231 and 232 for redirecting light reaching second end 214. Angled facets 231 and 232 may result in a substantially triangular cross-section for the portions of LGA 210 at end 214.

FIG. 2B are side, end and top views of a light guide array in accordance with some embodiments of the invention. LGA 210, shown in FIG. 2B, can correspond to the LGA of fixture 200.

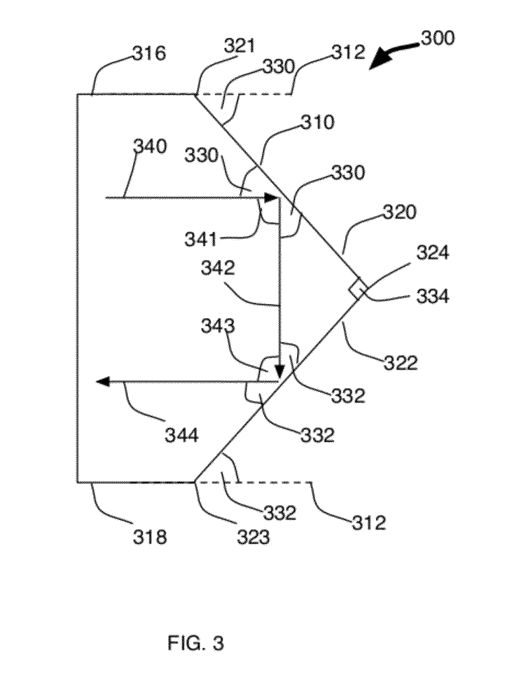

FIG. 3 is a detailed view of a second end of a modified LGA in accordance with some embodiments of the invention. LGA 300, which can be elongated along at least one axis, can include upper surface 316 and lower surface 318 that meet at end 310. In some cases, surfaces 316 and 318 can correspond to elongated edges or sides of LGA 300. End 310 can be opposite an end of LGA 300 at which light enters the LGA, such that light that has not left LGA 300 through upper surface 316 may reach end 310.

To improve the efficiency of LGA 300, end 310 can include angled facets 320 and 322 defining a retroreflective element on a trailing edge of the LGA. In particular, facet 320 can extend from end point 321 of upper surface 316 to tip 324, and facet 322 can extend from end point 323 of lower surface 318 to tip 324. Each of facets 320 and 322 can be angled such that tip 324 is farther from the LED module than either end points 321 or 323. In some cases, ends points 321 and 323 can be substantially the same distance from the LED module (e.g., from an end opposite end 310 of LGA 300). End 310 may include a substantially triangular cross-section, where a triangle is defined by ends points 321 and 323 and tip 324.

Although light emitted by a LED module may initially have Lambertian distribution, after propagating through an elongated LGA, the distribution of light may change and become more collimated. In particular, as light is frustrated by LGA 300 and leaves the guide, the remaining light reaching end 310 may be substantially parallel to axis 312 of LGA 300 (e.g., within a plane defined by upper surface 316 or lower surface 318). Facets 320 and 322 can therefore be defined such that light reaching one of the facets along the axis of LGA 300 may be turned around and re-directed back into LGA 300.

Each of facets 320 and 322 can have any suitable angle relative to axis 312. For example, facet 320 can be angled at angle 330 relative to axis 312, and facet 322 can be angled at angle 332 relative to axis 312. Angles 330 and 332 can be selected based on any suitable criteria. In some cases, the angles can be selected to ensure that light reaching a facet will be reflected by the facet due to the critical angle for total reflection corresponding to the index of refraction between the material of LGA 300 and the air in which LGA 300 is placed. For example, angles 330 and 332 can be selected to be larger than 42 degrees when the index of refraction of the LGA/air interface is 1.5. In one implementation, each of angles 330 and 332 is substantially equal to 45 degrees.

Facets 320 and 321 can have any suitable angle relative to one another at tip 324. In some cases, angle 334 at tip 324 can be selected such that light reaching one of facets 320 and 322 can be reflected to the other of the facets, and then back along axis 312 away from end 310. In one implementation, angle 334 can be substantially equal to 90 degrees. Then, light 340 initially reaching facet 320 along axis 312 can be reflected at an angle equal to twice angle 330 towards facet 322 (e.g., 90 degrees if angle 330 is 45 degrees) as light 342, and again reflected at an angle equal to twice angle 332 away from end 310 along axis 312 as light 344 (e.g., 90 degrees if angle 332 is 45 degrees). In particular, facets 320 and 322 can be angled such that the sum of angle 341 between light 340 and 342, and angle 343 between light 342 and 344 is equal to 180 degrees, thus indicating that light is reflected back along axis 312 toward the LED module of the fixture. In some cases, however, light 340 may not be truly collimated, and may therefore retro reflect at an angle other than 180 degrees such that the retroreflected light can encounter a feature of LGA 300 (e.g., a rib) and be frustrated.

Facets 320 and 322 can be constructed using different approaches. In some cases, facets can be cut (e.g., using a machining process), or molded with the LGA. Alternatively, other manufacturing processes can be used to remove material from a LGA and create substantially planar facets. In some cases, the facets can instead or in addition have curved or variable shapes, for example depending on the material used to create the LGA, or on expected angles of incident light in different regions of each facet. In some cases, the surfaces of facets 320 and 322 can be processed to improve their reflectivity. For example, the surfaces of facets 320 and 322 can be polished (e.g., using an abrasive tool). As another example, an external component or coating of a highly reflective material (e.g., a metal) can be applied to the surfaces of facets 320 and 322.

LGA 300 can be constructed from any suitable material. In some cases, the material used can be selected such that the index of refraction between the material and air is approximately 1.5. More generally, the material can be selected such that the index of refraction is in a range that allows for adjacent facets to be angled at 90 degrees relative to one another while ensuring that the angle between an axis of the LGA and each of the facets is more than the critical angle for the index of refraction. Such materials can include, for example, an acrylic, polycarbonate, glass, or another plastic material that is substantially transparent. Using these materials, total internal reflection can be achieved, and therefore improve the efficiency of the LGA without substantially effecting the cost. In some cases, the materials may require a secondary process or cap to ensure total or near total reflection of light within the LGA.

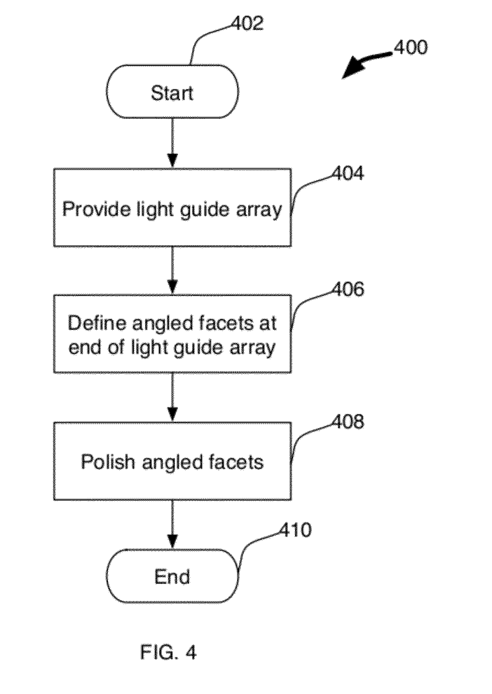

FIG. 4 is a flow chart of an illustrative process for constructing a light guide array having a retroreflective element in accordance with some embodiments of the invention. Process 400 can begin at step 402. At step 404, a light guide array can be provided. For example, an optically transparent material can be retrieved and shaped to fit in a light fixture. In some cases, the material can be provided substantially as a rectangular prism. The light guide array can be elongated, such that light is provided at one end of the light guide array by a LED module is propagated through the entirety of the light guide array. At step 406, angled facets providing a retroreflective element can be defined at an end of the light guide array. For example, angled facets can be cut or molded into an end of the light guide array that is opposite the LED module. The angled facets can be provided at any suitable angle including, for example, at an angle selected to enhance total internal reflection of light reaching the angled facets. In one implementation, the angled facets can be provided at substantially 45 degree angles relative to an elongated axis of the light guide array. To ensure that light is reflected back along the elongated axis, the angled facets can be angled at 90 degrees relative to each other. At step 408, the angled facets can be polished. Alternatively, other optical treatments can be applied to the light guide array to enhance or improve a reflectivity of the angled facets. Process 400 can then end at step 410.

It is to be understood that the steps shown in process 400 of FIG. 4 are merely illustrative and that existing steps may be modified or omitted, additional steps may be added, and the order of certain steps may be altered. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above-described embodiments of the invention are presented for purposes of illustration and not of limitation.

What is claimed is:

1. A light fixture, comprising:
a LED module comprising a light emitting surface; and
a light guide array, comprising:
an elongated body comprising a first end opposite a second end, wherein the LED module is placed adjacent to the first end; and
at least two facets angled relative to an axis of the elongated body and forming an edge at the second end, wherein the at least two facets are angled at substantially 90 degrees relative to each other.

2. The light fixture of claim 1, wherein:
at least one of the at least two facets is angled relative to the axis at an angle larger than a critical angle associated with an interface between the light guide array and air.

3. The light fixture of claim 2, wherein:
each of the at least two facets is angled relative to the axis at substantially similar angles.

4. The light fixture of claim 3, wherein:
each of the at least two facets is angled at an angle of approximately 45 degrees relative to the axis.

5. The light fixture of claim 2:
the critical angle is substantially equal to 42 degrees.

6. The light fixture of claim 1, wherein:
the light guide array comprises a rectangular prism.

7. The light fixture of claim 1, wherein:
each of the facets is substantially planar.

8. The light fixture of claim 7, wherein:
each of the facets is polished to improve reflectivity of the facets.

9. A method for constructing a light guide array for use with a edge-lit LED light fixture, comprising:
providing a rectangular prism extending along an axis;
defining two angled facets at a trailing end of the prism, wherein each of the two angled facets is angled at an angle such that substantially collimated light along the axis of the prism reaching one of the two angled facets is totally reflected; and
polishing each of the two facets.

10. The method of claim 9, wherein defining further comprises:
defining the two angled facets such that they are perpendicular to each other.

11. The method of claim 10, wherein the light guide array is constructed from at least one of:
acrylic;
glass; and
polycarbonate.

12. The method of claim 9, wherein defining further comprises:
cutting the rectangular prism to create each of the two angled facets.

13. The method of claim 9, wherein defining further comprises:
molding the light guide array with the two angled facets.

14. The method of claim 9, further comprising:
applying a reflective element to a surface of each of the two angled facets.

15. The method of claim 9, further comprising:
placing a LED module adjacent to an end of the rectangular prism, wherein the end is opposite the trailing end relative to the axis.

16. An edge-lit LED light fixture, comprising:
a LED module comprising a light emitting surface;
a light guide array defining a rectangular prism having an elongated side, wherein:
the light emitting surface is placed adjacent to a first end of the light guide array; and
a second end of the light guide array opposite the first end comprises an angled edge defining a triangular cross-section, wherein dimensions of the angled edge are selected for total reflection of collimated light aligned with the elongated side.

17. The edge-lit LED fixture of claim 16, wherein:
the first end and the second end are at opposite ends of the elongated side.

18. The edge-lit LED fixture of claim 16, wherein the light guide array further comprises:
at least one rib for frustrating light emitted by the LED module.

19. The edge-lit LED fixture of claim 18, wherein:
the light guide array comprises an upper surface and a lower surface; and
frustrated light exits the light guide array through the upper surface.

20. The edge-lit LED fixture of claim 19, further comprising:
a reflective component placed adjacent to the lower surface.
